(19) United States
(12) Patent Application Publication
(10) Pub. No.: US 2008/0274385 A1
(43) Pub. Date: Nov. 6, 2008

(54) Fuel Cells

(76) Inventor: Andrew Martin Creeth, Chester (GB)

Correspondence Address: KNOBBE MARTENS OLSON & BEAR LLP, 2040 MAIN STREET, FOURTEENTH FLOOR, IRVINE, CA, 92614, US

(21) Appl. No.: 11/911,945

(22) PCT Filed: Mar. 10, 2006
(86) PCT No.: PCT/EP2006/060640

§ 371 Date: Oct. 18, 2007

(30) Foreign Application Priority Data
Mar. 12, 2005 (GB) 0505087.7

(51) Int. Cl. H01M 8/20; H01M 8/10

(52) U.S. Cl. 429/19; 429/30

(57) ABSTRACT

This invention concerns a redox fuel cell comprising an anode and a cathode separated by an ion selective polymer electrolyte-membrane, preferably a bi-membrane, the cathode comprising a cathodic material and a proton-conducting polymeric material; means for supplying a fuel to the anode region of the cell; means for supplying an oxidant to the cathode region of the cell; means for providing an electrical circuit between the anode and the cathode; a non-volatile redox couple in solution in flowing fluid communication with the cathode, the redox couple being at least partially reduced at the cathode in operation of the cell, and at least partially re-generated by reaction with the oxidant after such reduction at the cathode.

The present invention relates to fuel cells, in particular to indirect or redox fuel cells which have applications in microfuel cells for electronic and portable electronic components, and also in larger fuel cells for the automotive industry.

Fuel cells have been known for application in portable applications such as automotive technology and portable electronics for very many years, although it is only in recent years that fuel cells have become of serious practical consideration. In its simplest form, a fuel cell is an electrochemical energy conversion device that converts fuel and oxidant into reaction product(s), producing electricity and heat in the process. In one example of such a cell, hydrogen is used as fuel, and air or oxygen as oxidant and the product of the reaction is water. The gases are fed respectively into catalysing, diffusion-type electrodes separated by a solid or liquid electrolyte which carries electrically charged particles between the two electrodes. In an indirect or redox fuel cell, the oxidant (and/or fuel in some cases) is not reacted directly at the electrode but instead reacts with the reduced form (oxidized form for fuel) of a redox couple to oxidise it, and this oxidised species is fed to the cathode.

There are several types of fuel cell characterised by their different electrolytes. The liquid electrolyte alkali electrolyte fuel cells have inherent disadvantages in that the electrolyte dissolves CO₂ and needs to be replaced periodically. Polymer electrolyte or PEM-type cells with proton-conducting solid cell membranes are acidic and avoid this problem. However, it has proved difficult in practice to attain power outputs from such systems approaching the theoretical maximum level, due to the relatively poor electrocatalysis of the oxygen reduction reaction. In addition expensive noble metal electrocatalysts are often used.

U.S. Pat. No. 3,152,013 discloses a gaseous fuel cell comprising a cation-selective permeable membrane, a gas permeable catalytic electrode and a second electrode with the membrane being positioned between the electrodes and in electrical contact only with the gas permeable electrode. An aqueous catholyte is provided in contact with the second electrode and the membrane the catholyte including an oxidant couple therein. Means are provided for supplying a fuel gas to the permeable electrode, and for supplying a gaseous oxidant to the catholyte for oxidising reduced oxidant material. The preferred catholyte and redox couple is HBr/KBr/Br₂. Nitrogen oxide is disclosed as a preferred catalyst for oxygen reduction, but with the consequence that pure oxygen was required as oxidant, the use of air as oxidant requiring the venting of noxious nitrogen oxide species.

An acknowledged problem concerning electrochemical fuel cells is that the theoretical potential of a given electrode reaction under defined conditions can be calculated but never completely attained. Imperfections in the system inevitably result in a loss of potential to some level below the theoretical potential attainable from any given reaction. Previous attempts to reduce such imperfections include the selection of catholyte additives which undergo oxidation-reduction reactions in the catholyte solution. For example, U.S. Pat. No. 3,294,588 discloses the use of quinones and dyes in this capacity. Another redox couple which has been tried is the vanadate/vanadyl couple, as disclosed in U.S. Pat. No. 3,279,949.

According to U.S. Pat. No. 3,540,933, certain advantages could be realised in electrochemical fuel cells by using the same electrolyte solution as both catholyte and anolyte. This document discloses the use of a liquid electrolyte containing more than two redox couples therein, with equilibrium potentials not more than 0.8V apart from any other redox couple in the electrolyte.

The matching of the redox potentials of different redox couples in the electrolyte solution is also considered in U.S. Pat. No. 3,360,401, which concerns the use of an intermediate electron transfer species to increase the rate of flow of electrical energy from a fuel cell.

Prior art fuel cells all suffer from one or more of the following disadvantages:

They are inefficient; they are expensive and/or expensive to assemble; they use expensive and/or environmentally unfriendly materials; they yield inadequate current density and/or inadequate potential; they are too large in their construction; they operate at too high a temperature; they produce unwanted by-products and/or pollutants and/or noxious materials; they have not found practical commercial utility in portable applications such as automotive technology and portable electronics.

It is an object of the present invention to overcome or ameliorate one or more of the aforesaid disadvantages.

Accordingly, the present invention provides a redox fuel cell comprising an anode and a cathode separated by an ion selective polymer electrolyte membrane the cathode comprising a cathodic material and a proton-conducting polymeric material; means for supplying a fuel to the anode region of the cell; means for supplying an oxidant to the cathode region of the cell; means for providing an electrical circuit between the anode and the cathode; a non-volatile redox couple in solution in flowing fluid communication with the cathode, the redox couple being at least partially reduced at the cathode in operation of the cell, and at least partially re-generated by reaction with the oxidant after such reduction at the cathode.

The incorporation of a proton conducting polymer in the material of the cathode provides surprising advantages in the redox fuel cell of the invention by increasing the current density in the cell. The proton conducting polymer is preferably located on or towards the anodic side of the cathode and may be adjacent the cathode surface or may be anchored in the cathode surface, or within or through the cathode or a surface region thereof.

Preferably the polymer electrolyte membrane comprises a bimembrane. Preferably the bimembrane comprises an adjacent pairing of oppositely charge selective membranes. For example the bi-membrane may comprise at least two discreet membranes which may be placed side-by-side with an optional gap therebetween. Preferably the size of the gap, if any, is kept to a minimum in the redox cell of the invention. The use of a bi-membrane can be important in the redox fuel cell of the invention to maximise the potential of the cell, by maintaining the potential due to a pH drop between the anode and catholyte solution. Without being limited by theory, in order for this potential to be maintained in the membrane system, at some point in the system, protons must be the dominant charge transfer vehicle. A single cation-selective membrane would not achieve this to the same extent due to the free movement of other cations from the catholyte solution into the membrane, or the creation of a junction in solution of low potential.

The fuel cell of the invention utilises a bi-membrane which generally comprises a first cation selective membrane and a second anion selective membrane.

In a first embodiment of the invention the cation selective membrane is positioned on the cathode side of the bi-membrane and the anion selective membrane is positioned on the anode side of the bi-membrane. In this case, the cation selective membrane is adapted to allow protons to pass through the membrane from the anode side to the cathode side thereof in operation of the cell. The anion selective membrane is adapted substantially to prevent cationic materials from passing therethrough from the cathode side to the anode side thereof, although in this case anionic materials may pass from the cathode side of the anionic-selective membrane to the anode side thereof, whereupon they may combine with protons passing through the membrane in the opposite direction. Preferably the anion selective membrane is selective for hydroxyl ions, and combination with protons therefore yields water as product.

In a second embodiment of the invention the cation selective membrane is positioned on the anode side of the bi-membrane and the anion selective membrane is positioned on the cathode side of the bi-membrane. In this case, the cation selective membrane is adapted to allow protons to pass through the membrane from the anode side to the cathode side thereof in operation of the cell. In this case, anions can pass from the cathode side into the interstitial space of the bimembrane, and protons will pass from the anode side. It may be desirable in this case to provide means for flushing such protons and anionic materials from the interstitial space of the bimembrane. Such means may comprise one or more perforations in the cation selective membrane, allowing such flushing directly through the membrane. Alternatively means may be provided for channeling flushed materials around the cation selective membrane from the interstitial space to the cathode side of the said membrane.

In one preferred embodiment of the invention, the ion selective PEM is a cation selective membrane which is selective in favour of protons versus other cations.

The cation selective membrane may be formed from any suitable material, but preferably comprises a polymeric substrate having cation exchange capability. Suitable examples include fluororesin-type ion exchange resins and non-fluororesin-type ion exchange resins. Fluororesin-type ion exchange resins include perfluorocarboxylic acid resins, perfluorosulfonic acid resins, and the like. Perfluorocarboxylic acid resins are preferred, for example “Nafion” (Du Pont Inc.), “Flemion” (Asahi Gas Ltd), “Aciplex” (Asahi Kasei Inc), and the like. Non-fluororesin-type ion exchange resins include polyvinyl alcohols, polyalkylene oxides, styrene-divinylbenzene ion exchange resins, and the like, and metal salts thereof. Preferred non-fluororesin-type ion exchange resins include polyalkylene oxide-alkali metal salt complexes. These are obtainable by polymerizing an ethylene oxide oligomer in the presence of lithium chlorate or another alkali metal salt, for example. Other examples include phenolsulphonic acid, polystyrene sulphonic, polytrifluorostyrene sulphonic, sulphonated trifluorostyrenei, sulphonated copolymers based on α,β,β trifluorostyrene monomer, radiation-grafted membranes. Non-fluorinated membranes include sulphonated poly(phenylquinoxalines), poly (2,6 diphenyl-4-phenylene oxide), poly(arylether sulphone), poly(2,6-diphenylenol); acid-doped polybenzimidazole, sulphonated polyimides; styrene/ethylene-butadiene/styrene triblock copolymers; partially sulphonated polyarylene ether sulphone; partially sulphonated polyether ether ketone (PEEK); polybenzyl suphonic acid siloxane (PBSS).

The anion selective membrane may be formed from any suitable material but preferably comprises a polymeric substrate having anion exchange capability. Suitable examples include quaternary amine derivatives of styrene cross-linked with divinyl benzene and polymerised in the presence of finely powdered polyvinyl chloride to provide strength.

A representative example of a useful bipolar membrane, the arrangement used with the anionic-selective membrane on the anode side is that sold under the trademark Neosepta® BP-1, available from Tokuyama Corporation.

The preferred thickness of the bi-membrane for a hydrogen fuel cell is less than 200 microns, more preferably less than 100 microns, most preferably less than 75 microns. For a methanol or other low alcohol-type cell, the preferred thickness is less than 300 microns, more preferably less than 200 microns.

The electrodes of the cell and the polymer electrolyte bi-membrane are preferably arranged in the cell in a sandwich type construction, the cell comprising an anode chamber on the anode side of the sandwich construction, and means for supplying a fuel to the anode chamber, and a cathode chamber on the cathode side of the sandwich construction, and means for supplying an oxidant to the cathode chamber.

The fuel cell of the invention may comprise a reformer configured to convert available fuel precursor such as LPG, LNG, gasoline or methanol into a fuel gas (eg hydrogen) through a steam reforming reaction. The cell may then comprise a fuel gas supply device configured to supply the reformed fuel gas to the anode chamber

It may be desirable in certain applications of the cell to provide a fuel humidifier configured to humidify the fuel, e.g. hydrogen. The cell may then comprise, a fuel supply device configured to supply the humidified fuel to the anode chamber.

An electricity loading device configured to load an electric power may be provided.

Preferred fuels include hydrogen; low molecular weight alcohols, aldehydes and carboxylic acids, sugars and biofuels.

Preferred oxidants include air, oxygen and peroxides

The use of a proton conducting polymeric material in the cathode is important in the redox fuel cell of the invention because resistance to the flow of protons into the cathode is thereby reduced which, in turn, increases the current density of the cell. Additionally, the proton conducting polymeric material may serve to repel the passage of anions, in particular anions bearing a charge of less than −1, from passing into the membrane. The proton conducting polymeric material may be situated adjacent to the cathode surface facing the membrane (or bi-membrane) or may be anchored to the cathode on the surface thereof facing the (bi) membrane. Alternatively, the proton conducting material may be more fully interspersed in a surface region of the cathodic material, even to the extent that the surface of the cathode effectively comprises a heterogeneous material comprising the cathodic material interspersed with the proton conducting polymeric material.

The proton conducting polymeric material may be selected from the same material or materials forming the cation selective part of the bi-membrane. Alternatively, the proton conducting polymeric material may be selected from a different material from that of the cation selective part of the bi-membrane.

One possible advantage of the invention with respect to the desirability of improving the potential of the cell and maintaining the current density thereof is that system provides an adsorbed anionic polymer providing conduction pathway for protons and other cations.

The proton conducting polymeric material may be formed from any suitable material, but preferably comprises a polymeric substrate having cation exchange capability. Suitable examples include Nafion™, phenolsulphonic acid, polystyrene sulphonic, polytrifluorostyrene suiphonic, sulphonated trifluorostyrene, sulphonated copolymers based on α,β,β trifluorostyrene monomer, radiation-grafted membranes. Non-fluorinated materials include sulphonated poly(phenylquinoxalines), poly (2,6 diphenyl-4-phenylene oxide), poly(arylether sulphone), poly(2,6-diphenylenol); acid-doped polybenzimidazole, sulphonated polyimides; styrene/ethylene-butadiene/styrene triblock copolymers; partially sulphonated polyarylene ether sulphone; partially sulphonated polyether ether ketone (PEEK); polybenzyl suphonic acid siloxane (PBSS).

The anode in the redox fuel cell of the invention may for example be a hydrogen gas anode or a direct methanol anode; other low molecular weight alcohols such as ethanol, propanol, dipropylene glycol; ethylene glycol; also aldehydes formed from these and acid species such as formic acid, ethanoic acid etc. may also used as anodic fuel. Also sodium borohydride may be used directly or as a source of hydrogen fuel with a suitable catalyst. In addition the anode may be formed from a bio-fuel cell type system where a bacterial species consumes a fuel and either produces a mediator which is oxidized at the anode, or the bacteria themselves are adsorbed at the anode and directly donate electrons to the anode. Suitable anodic materials will be apparent to the skilled person and may include, by way of example only, Pt/C-type dispersions, with or without suitable binders, proton-conducting polymeric materials, and may include a gas diffusion layer of carbon or carbon cloth for example. Other suitable electrocatalytic materials may be used in addition to or instead of platinum.

The cathode in the redox fuel cell of the invention may comprise as cathodic material carbon, platinum, nickel, metal oxide species. However, it is preferable that expensive cathodic materials are avoided, and therefore preferred cathodic materials include carbon, nickel, metal oxide. The cathodic material may be constructed from a fine dispersion of particulate cathodic material, the particulate dispersion being held together by a suitable adhesive, or simply by the proton conducting polymeric material. The cathode is designed to create maximum flow of redox mediator to the cathode surface. Thus it may consist of shaped flow regulators or a three dimensional electrode; the liquid flow may be managed in a flow-by arrangement where there is a liquid channel adjacent to the electrode, or in the case of the three dimensional electrode, where the liquid is forced to flow through the electrode. It is intended that the surface of the electrode is also the electrocatalyst, but it may be beneficial to adhere the electrocatalyst in the form of deposited particles on the surface of the electrode.

The redox couple flowing in solution in the cathode chamber in operation of the cell is used in the invention as a catalyst for the reduction of oxygen in the cathode chamber, in accordance with the following (wherein Sp is the redox couple species).

O₂+4Sp_{red}+4H⁺→2H₂O+4Spₒₓ

Ideally the redox couple utilised in the fuel cell of the invention should be non-volatile, and preferably be soluble in aqueous solvent. Preferred redox couples should react with the oxidant at a rate effective to generate a useful current in the electrical circuit, and react with the oxidant such that water is the ultimate end product of the reaction.

There are many suitable examples including ligated transition metal complexes and polyoxometallate species. Specific examples of suitable transition metals ions which can form such complexes include manganese in oxidation states II-V, Iron I-IV, copper I-III, cobalt I-III, nickel I-III, chromium (II-VII), titanium II-IV, tungsten IV-VI, vanadium II-V and molybdenum II-VI. Ligands can contain carbon, hydrogen, oxygen, nitrogen, sulphur, halides, phosphorus. Ligands may be chelating complexes include Fe/EDTA and Mn/EDTA, NTA, 2-hydroxyethylenediaminetriacetic acid, or non-chelating such as cyanide.

Metal ligand combinations known for their oxygen reduction properties include metal porphyrin and phthalocyanine derivatives e.g. Co(II)(/Fe(II)/Mn(II)) 4,4′,4″,4′″ Tetrasulphophthalocyanine 2 hydrate; Fe(II)/Co(II) octamethoxyphthalocyanine compounds and co-facial porphyrins with two metal porphyrin centres that face one-another.

Bipyridyl and phenanthroline derivatives of iron are a preferred redox mediator and ferri/ferrocyanide. All of these have highly reversible electrochemical reactions.

Specific examples of polyoxometallates include molybdophosphoric acid, H₃PMo₁₂ O₄₀ and molybdovanadophosphosphoric acid, H₅PMo₁₀V₂O₄₀.

The fuel cell of the invention may operate straightforwardly with a redox couple catalysing in operation of the fuel cell the reduction of oxidant in the cathode chamber. However, in some cases, and with some redox couples, it may be necessary and/or desirable to incorporate a catalytic mediator in the cathode chamber.

The invention will now be more particularly described with reference to the drawings, in which:

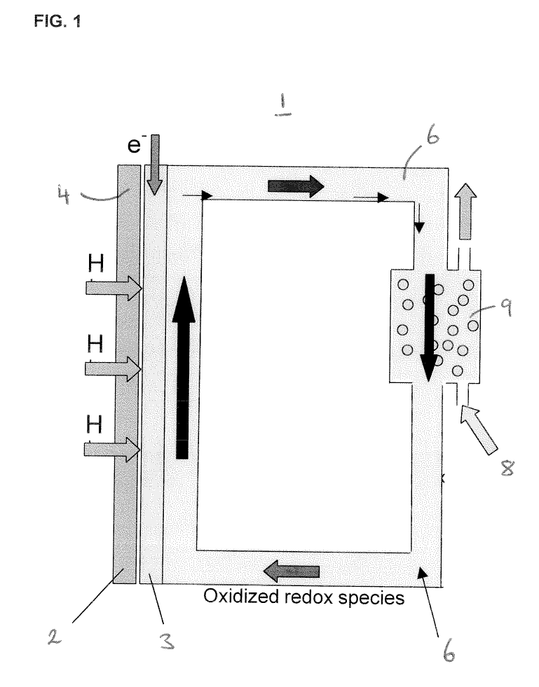

FIG. 1 shows a schematic view of the cathode side of a conventional redox fuel cell;

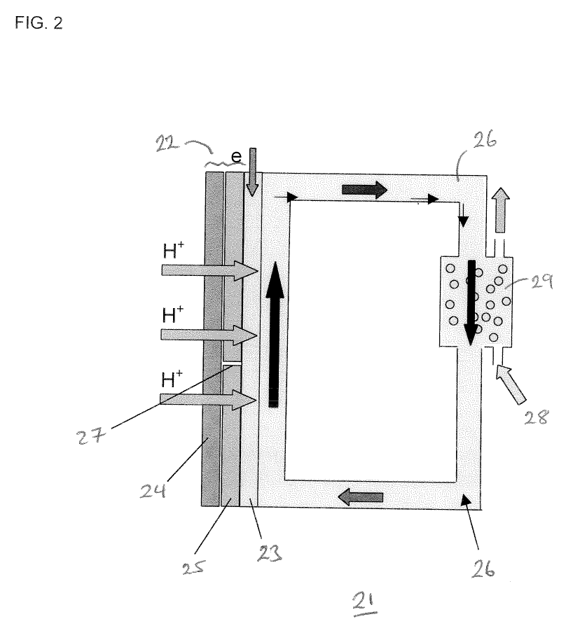

FIG. 2 shows a schematic view of the cathode side of a first fuel cell in accordance with the invention;

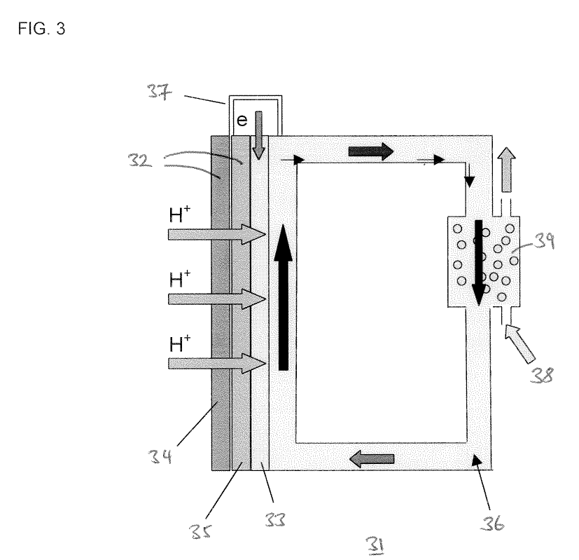

FIG. 3 shows a schematic view of the cathode side of a second fuel cell in accordance with the invention;

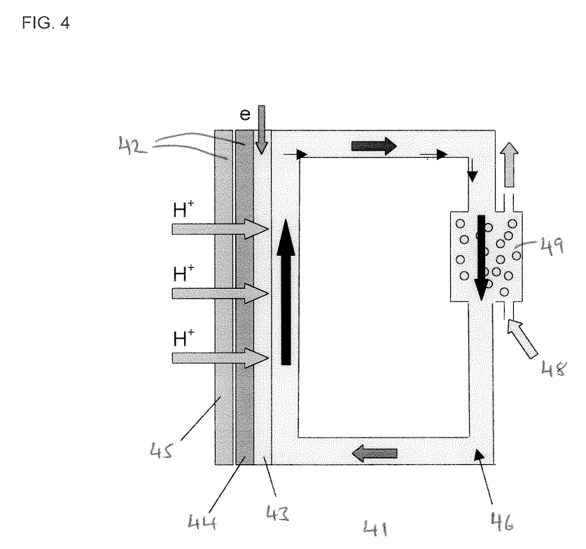

FIG. 4 shows a schematic view of the cathode side of a third fuel cell in accordance with the invention;

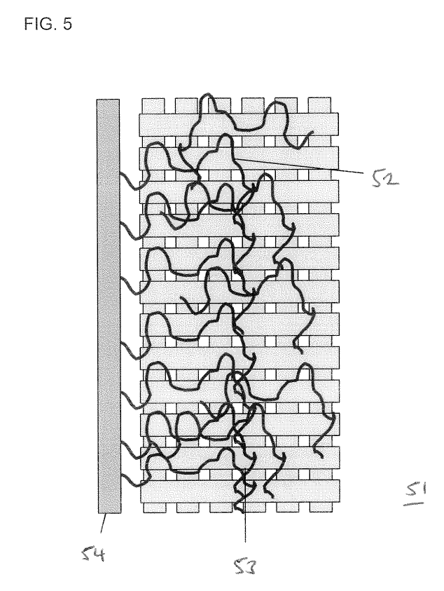

FIG. 5 shows a schematic view of the surface region only of an anchored proton-conducting cathode for use in the fuel cell of the invention;

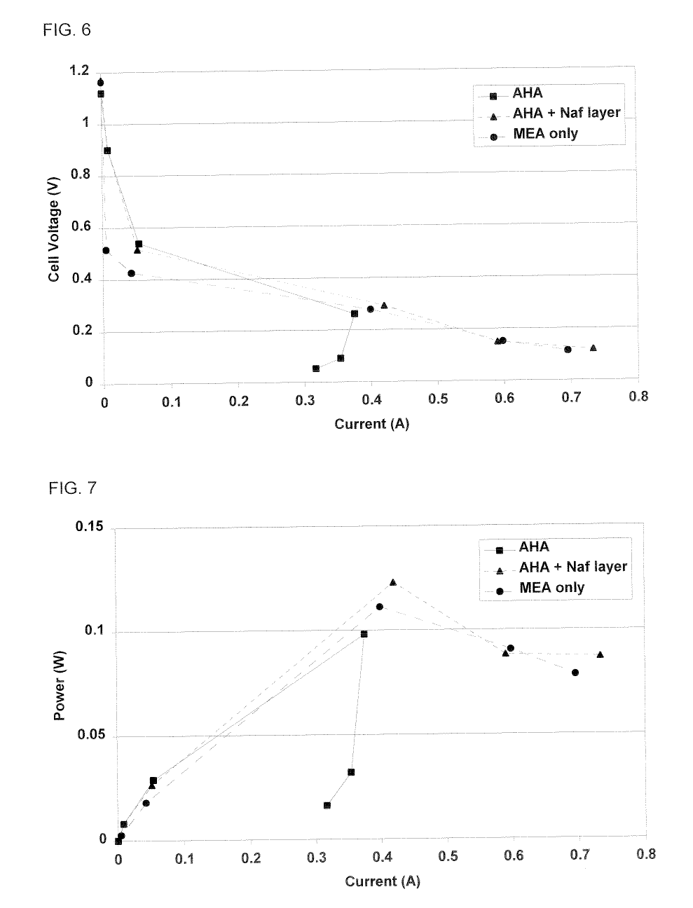

FIG. 6 shows a plot of current and voltage characteristics for the AHA membrane systems with a catholyte solution of 0.1 M Feic in 1 M KOH at 50° C., and is referred to below in Example 3;

FIG. 7 shows a plot of current and power characteristics for the AHA membrane systems with a catholyte solution of 0.1M Feic in 1M KOH at 50° C., and is referred to below in Example 3;

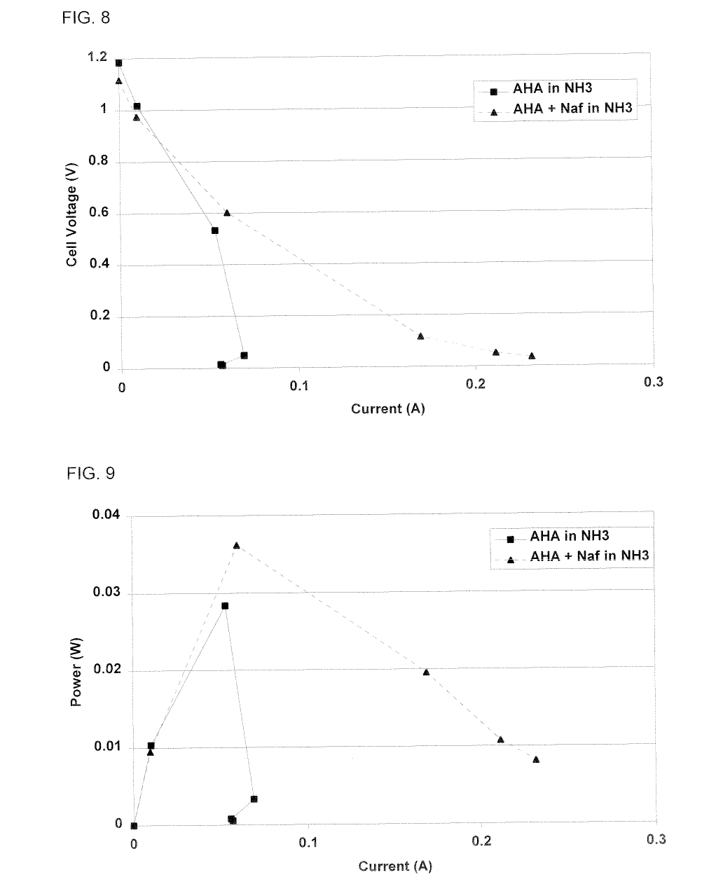

FIG. 8 shows a plot of current and voltage characteristics for the AHA membrane systems with a catholyte solution of 0.1M Feic in 0.5M NH₃ at 50° C., and is referred to below in Example 3; and

FIG. 9 shows a plot of current and power characteristics for the AHA membrane systems with a catholyte solution of 0.1M Feic in 0.5M NH₃ at 50° C., and is referred to below in Example 3.

Referring to FIG. 1, there is shown the cathode side of fuel cell 1 comprising a polymer electrolyte membrane 2 separating an anode (not shown) from cathode 3. Polymer electrolyte membrane 2 comprises cation selective membrane 4 through which protons generated by the (optionally catalytic) oxidation of fuel gas (in this case hydrogen) in the anode chamber pass in operation of the cell. Electrons generated at the anode by the oxidation of fuel gas flow in an electrical circuit (not shown) and are returned to cathode 3. Fuel gas (in this case hydrogen) is supplied to the fuel gas passage of the anode chamber (not shown), while the oxidant (in this case air) is supplied to oxidant inlet 8 of cathode chamber 6. Gas reaction chamber 9 is provided in the region of oxidant inlet, wherein the oxidant is reduced by the redox species flowing in cathode chamber 6.

Referring to FIG. 2, there is shown the cathode side of fuel cell 21 comprising a polymer electrolyte bimembrane 22 separating an anode (not shown) from cathode 23. Cathode 23 comprises carbon as cathode material, anchored with a proton-conducting polymer, and is described in more detail below in connection with FIG. 5. Polymer electrolyte bimembrane 22 comprises, on the anode side of the cell, cation selective Nafion 112 membrane 24 through which protons generated by the (optionally catalytic) oxidation of fuel gas (in this case hydrogen) in the anode chamber pass in operation of the cell Adjacent cation selective membrane 24 is anion selective membrane 25 manufactured from AMX std from Eurodia Industrie SA, through which hydroxyl ions may pass from the cathode chamber 26 in operation of the cell. Electrons generated at the anode by the oxidation of fuel gas flow in an electrical circuit (not shown) and are returned to cathode 23. Anion selective membrane 25 is provided with pinholes 27 (only one of which is illustrated in FIG. 1) to allow anions from cathode chamber 26 which have passed through anion selective membrane 25 to return to cathode chamber 26. Fuel gas (in this case hydrogen) is supplied to the fuel gas passage of the anode chamber (not shown), while the oxidant (in this case air) is supplied to oxidant inlet 28 of cathode chamber 26. Gas reaction chamber 29 is provided in the region of oxidant inlet, wherein the oxidant is reduced by the redox species flowing in cathode chamber 26.

Referring to FIG. 3, there is shown the cathode side of fuel cell 31 comprising a polymer electrolyte bimembrane 32 separating an anode (not shown) from cathode 33. Cathode 33 comprises carbon as cathode material, anchored with a proton-conducting polymer, and is described in more detail below in connection with FIG. 5. Polymer electrolyte bimembrane 32 comprises, on the anode side of the cell, cation selective Nafion 112 membrane 34 through which protons generated by the (optionally catalytic) oxidation of fuel gas (in this case hydrogen) in the anode chamber pass in operation of the cell. Adjacent cation selective membrane 34 is anion selective membrane 35 manufactured from AMX std from Eurodia Industrie SA, through which hydroxyl ions may pass from the cathode chamber 36 in operation of the cell. Electrons generated at the anode by the oxidation of fuel gas flow in an electrical circuit (not shown) and are returned to cathode 33. Anion selective membrane 35 is provided with bypass line 37 to allow cations from cathode chamber 36 which have passed through anion selective membrane 35 to return to cathode chamber 36. Fuel gas (in this case hydrogen) is supplied to the fuel gas passage of the anode chamber (not shown), while the oxidant (in this case air) is supplied to oxidant inlet 38 of cathode chamber 36. Gas reaction chamber 39 is provided in the region of oxidant inlet, wherein the oxidant is reduced by the redox species flowing in cathode chamber 36. Referring to FIG. 4, there is shown the cathode side of fuel cell 41 comprising a polymer electrolyte bimembrane 42 separating an anode (not shown) from cathode 43. Cathode 43 comprises carbon as cathode material, anchored with a proton-conducting polymer, and is described in more detail below in connection with FIG. 5. Polymer electrolyte bimembrane 42 comprises, on the cathode side of the cell, cation selective Nafion 112 membrane 44 through which protons generated by the (optionally catalytic) oxidation of fuel gas (in this case hydrogen) in the anode chamber pass in operation of the cell. Adjacent cation selective membrane 44 but this time on the anode side of the cell is anion selective membrane 45. An example of this bipolar membrane arrangement is that sold under the trademark Neosepta® BP-1, available from Tokuyama Corporation, through which protons may also pass into cathode 43, through which they are conducted to cathode chamber 6 in operation of the cell. Electrons generated at the anode by the oxidation of fuel gas flow in an electrical circuit (not shown) and are returned to cathode 43. Anion selective membrane 45 is not provided with pinholes or bypass tube, which are unnecessary in this arrangement. Fuel gas (in this case hydrogen) is supplied to the fuel gas passage of the anode chamber (not shown), while the oxidant (in this case air) is supplied to oxidant inlet 48 of cathode chamber 46. Gas reaction chamber 49 is provided in the region of oxidant inlet, wherein the oxidant is reduced by the redox species flowing in cathode chamber 46.

Referring now to FIG. 5 there is shown the surface region of a carbon-containing cathode 51 anchored with a proton conducting polymer 52 (in this case Nafion 117). The cathode comprises a carbon based substrate 53 which, in the schematic exemplification shown in this figure, is based on carbon paper, interspersed in its surface region with the proton conducting polymer. The polymer may also be anchored to bimembrane 54 as shown in the figure. There are many suitable methods of constructing the cathode. For example, a solution (for example a solution in low molecular weight alcohol/aqueous solution) of the polymer may be applied to the optionally porous carbonic substrate may painting, spraying, screen printing or by adsorption from solution in which the substrate is dipped. The proton conducting material need not be anchored in the cathode, but may simply be situated adjacent to the cathode surface between the cathode and the membrane.

The invention will now be more particularly described with reference to the following examples.

### EXAMPLE 1

Oxidation of Mn(II) to Mn(III), then production of the electroactive species, ferricyanide from ferrocyanide.

A solution of the ligand, 2-hydroxyethylenediaminetriacetic acid—0.02 M, and Manganous sulphate 0.01M was prepared and nitrogen bubbled through the solution. Potassium ferrocyanide solution was added to obtain a concentration of 0.005 M.

The gas supply was changed to oxygen and 1 cm³ of 1 M NaOH was added to take the pH to 11.6. After five minutes an intense orange colour had formed and the gas supply was switched back to nitrogen. 3.9 ml of 0.1 M H₂SO₄ was added to obtain a yellow solution of at pH 8.5. The concentration of ferricyanide ion was determined by UV-visible spectrophotometry to be 0.0033 M.

### EXAMPLE 2

This Example concerns the use of a bi-membrane for systems at higher pH.

A fuel cell was constructed using a Pt-based anode, a carbon paper cathode and two membranes, one anion-selective and one cation-selective. Hydrogen was used as the fuel and a ferricyanide solution in phosphate buffer as the catholyte.

The anode was constructed from a dispersion of Pt (20%)-containing carbon dispersion (Alfa Aesar) on carbon paper Toray TGPH-090. The level of Pt was 3 mgcm-2 with 1 mg cm-2 of Nafion added from a 2:1 water to IPA suspension, then dried. A further layer of 1 mg cm-2 of Nafion was added.

The cathode was constructed from the carbon paper with a layer of 1 mg cm-2 of Nafion added.

The cationic-selective membrane was Nafion 115; the anionic-selective membrane was AMX std from Eurodia

The membranes were arranged with the cation-selective membrane adjacent to the anode and the anion-selective membrane adjacent to the cathode. Two pin-holes were placed in the anion selective membrane, one within the electrode area and one outside.

Hydrogen was generated from a sodium borohydride solution at 70° C., and introduced to the anode at low pressure.

The catholyte consisted of 0.3 M potassium ferricyanide in a phosphate buffer of 0.125 M K₂HPO₄ and 0.125 M KH₂PO₄.

The catholyte was heated to 70° C., and introduced to the fuel cell which was separately heated.

An open circuit potential of 0.64 V was obtained.

### COMPARATIVE EXAMPLE

For comparison with Example 2, another experiment was carried out using only the cationic ion selective membrane, Nafion 112: no anionic selective membrane was incorporated. A similar anode was used, but this time a Pt-containing cathode; the same ferricyanide catholyte solution. A potential of 0.42 V was obtained, i.e. 0.24 V lower than the potential obtained by the bi-membrane in accordance with the fuel cell of the invention.

### EXAMPLE 3

Measurements were taken with an anodic membrane electrode assembly (half-MEA) available from Ionpower under the designation MEA—N1135. The MEA as supplied consisted of a Nafion™ substrate membrane coated on one side only with a Pt/C Nafion™ dispersion. The active area was 7 cm×7 cm and the overall dimensions were 10 cm×10 cm. The platinum loading was 0.3 mg cm⁻² and the thickness of the membrane was 0.09 mm.

In this Example different anionic membranes were inserted between the Nafion™ membrane side of the MEA and, in assembly with the half-MEA a nickel cathode. The anionic membranes used were as follows:
Eurodia AHA membrane (comparative)
Eurodia AHA membrane with 2 mg/cm² Nafion coating (according to the invention)
No anionic membrane (comparative)

In this example of the invention the Eurodia AHA membrane was coated on its cathode side with the proton conducting polymeric material Nafion™ which, when pressed in assembly against the cathode, formed part of an assembly in which the cathode comprised a cathodic material (in this case nickel foam, with a nickel mesh protective cover to prevent the foam from piercing the membrane) and a proton conducting polymeric material (in this case Nafion™).

The fuel cell was thus assembled and supplied with catholyte at a temperature of 50° C., and at a flow rate of 1000 ml/min.

Hydrogen gas was supplied to the anode side at a flow rate of 180 ml/min.

In this Example two catholyte solutions were used:
0.1M Ferricyanide (Feic) in 1M Potassium Hydroxide.
0.1M Feic in 0.5M NH₄OH.

The different membrane assemblies were tested according to the same regimen, evaluating the Open circuit voltage and current output for given resistive loads. FIGS. 6 and 8 present the current/voltage data for the KOH and NH₃ catholyte systems, respectively. FIGS. 7 and 9 show the current/power curves for the two catholyte systems.

It can be seen for both catholyte systems that the presence of the Nafion™ layer significantly increases the current output from the cell, when compared to the uncoated anionic membrane. It can also be seen that the Nafion™ coated membrane gives similar or greater current to the MEA on its own. Use of the coated bi-membrane offers the potential for greater selectivity in fuel cell design and it is believed that optimisation of the bi-membrane system (reducing its thickness for example) will yield further improvements. For example the combined thickness of the reinforced AHA membrane and the MEA gives a much higher electrolyte resistance than just the MEA on its own. A more sophisticated membrane assembly, working on the bi-membrane principle would be expected to provide even higher currents.

1-12. (canceled)

13. A redox fuel cell comprising:
an anode and a cathode separated by an ion selective polymer electrolyte membrane, the cathode comprising a cathodic material and a proton-conducting polymeric material;
a fuel inlet to the anode region of the cell;
an oxidant inlet to the cathode region of the cell; and
a non-volatile redox couple in solution, in flowing fluid communication with the cathode, the redox couple being at least partially reduced at the cathode in operation of the cell, and at least partially re-generated by reaction with an oxidant after such reduction at the cathode.

14. A fuel cell according to claim 13, wherein the membrane comprises an anion selective membrane.

15. A fuel cell according to claim 14, wherein the membrane is a bi-membrane.

16. A fuel cell according to claim 15, wherein the bi-membrane comprises at least two discreet membranes.

17. A fuel cell according to claim 15, wherein the bi-membrane comprises an adjacent pairing of oppositely charge selective membranes.

18. A fuel cell according to claim 17, wherein the bi-membrane comprises at least two discreet membranes.

19. A fuel cell according to claim 18, wherein the discreet membranes are placed side-by-side with an optional gap therebetween.

20. A fuel cell according to claim 15, wherein the bi-membrane comprises a first cation selective membrane and a second anion selective membrane.

21. A fuel cell according to claim 20, wherein the cation selective membrane is positioned on the cathode side of the bi-membrane and the anion selective membrane is positioned on the anode side of the bi-membrane.

22. A fuel cell according to claim 21, wherein, the anion selective membrane is selective for hydroxyl ions.

23. A fuel cell according to claim 21, wherein the proton conducting material comprises the cation selective membrane.

24. A fuel cell according to claim 22, wherein the anion selective membrane is selective for hydroxyl ions.

25. A fuel cell according to claim 20, wherein the cation selective membrane is positioned on the anode side of the bi-membrane and the anion selective membrane is positioned on the cathode side of the bi-membrane.

26. A fuel cell according to claim 25, wherein means are provided for flushing cationic materials from an interstitial space of the bi-membrane.
